(19) United States
(12) Patent Application Publication
(10) Pub. No.: US 2005/0159889 A1
(43) Pub. Date: Jul. 21, 2005

(54) Adaptive route guidance

(76) Inventor: Emad S. Isaac, Woodridge, IL (US)

Correspondence Address: Michael G. Fletcher;Fletcher Yoder, P.O. Box 692289, Houston, TX, 77269-2289, US

(21) Appl. No.: 10/760,997

(22) Filed: Jan. 20, 2004

(51) Int. Cl. G01C 21/34

(52) U.S. Cl. 701/210; 701/209; 340/995.19

(57) ABSTRACT

The disclosed embodiments may relate to a system including a vehicle (32) having a navigation system (10). The navigation system (10) having a processor (12), a positioning system (22), a memory (16), and a program (18). The positioning system (22) is coupled to the processor (12) and determines position data that relates to the location of the vehicle (32). The memory (16) is coupled to the processor (12) to store data for the processor (12). Further, the program (18) is used by the processor (12) and adapted to determine if position data and destination data correspond to an operator preferred route stored in memory (16). Also, the program (18) is further adapted to provide the operator preferred route if the position and destination data correspond to the operator preferred route. The program (18) also updates the operator preferred route by monitoring the position data.

### BACKGROUND INFORMATION

1. Field of the Invention

The present invention relates generally to a navigation system for a vehicle and, more particularly, to an adaptive route guidance system that is utilized to learn routes between designations.

2. Background of the Related Art

This section is intended to introduce the reader to various aspects of art that may be related to various aspects of the present invention described and/or claimed below. This discussion is believed to be helpful in providing the reader with background information to facilitate a better understanding of the various aspects of the present invention. Accordingly, it should be understood that these statements are to be read in this light, and not as admissions of prior art.

When traveling to a destination, maps and other guidance tools are generally used as aids in navigation. When traveling or preparing to travel in a vehicle, such as a car, road maps, by way of example, are used to gain an understanding of the roads that lead from one location to another. However, traditional maps (e.g. paper maps) may be unwieldy and difficult to manage. Moreover, traditional maps are difficult to update, and, as such, may provide outdated information.

In response, many vehicle manufacturers and after market suppliers offer electronic navigation systems for vehicles. Typically, electronic navigation systems include a memory component to store maps and other data, a global positioning transceiver, and a user interface with a display. Many of these navigation systems employ predetermined algorithms to determine a route between locations. The algorithms may determine the route between locations based on any number of parameters, such as minimizing fuel consumption, limiting travel time, maximizing average speed, and so forth. To determine the route, the algorithm may also employ various kinds of dynamic data, such as traffic congestion, road construction, and weather conditions, and the like. In addition, the algorithm may assign weights to the dynamic and stored data based on the parameters being used to determine the route, and, in response, use the weights to determine a route for a specific user.

However, for a variety of reasons, the navigation system may not generate a route that is optimal to a specific location and/or user. For instance, the navigational system may not be able to account for an individual's knowledge because it is not a part of the information that is incorporated into the data or the algorithms used to generate the optimal route. As such, the algorithm implemented in the navigation system may be unable to provide an optimal route that includes the actual impact of various obstacles generally known with specific experience with a specific route.

### BRIEF DESCRIPTION OF THE DRAWINGS

Advantages of the invention may become apparent upon reading the following detailed description and upon reference to the drawings in which:

FIG. 1 is a block diagram of a vehicle navigation system illustrated in accordance with an embodiment of the present invention;

FIG. 2 is a diagram of an exemplary navigation communication system including the vehicle navigation system of FIG. 1 illustrated in accordance with an embodiment of the present invention;

FIG. 3 is a diagram of alternative routes that may be provided by an exemplary navigation system illustrated in accordance with an embodiment of the present invention; and

FIG. 4 is a flow diagram of an exemplary process illustrated in accordance with an embodiment of the present invention.

### DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The present technique is an improved approach for incorporating an individual's knowledge when determining an optimal route via an electronic navigation system. Under the present technique, an operator may define a route, which may be a route that the operator has previously utilized a certain number of times, a route specified by an operator, and/or a route that is based on an individual's knowledge or experience. By utilizing a defined route, the navigation system operating under the present technique may present a default route or multiple routes between locations that incorporate the individual's knowledge or preferences in the route selection process.

For instance, while not limited in any way to such software programs, an embodiment of the navigation system may provide an operator of a vehicle with a preferred route that is based on the operator's knowledge and/or another operator's experience. The navigation system may utilize an origination location and a destination location in determining a route. With the location information, the navigation system may utilize algorithms or a user defined route to provide an optimal route. In providing a route, the navigation system may incorporate data, such as traffic congestion, road construction, accidents or weather conditions, to reflect the current road situations to determine the travel time along a specified route. As a result, the navigation system under the present technique may provide the operator with a route selection that utilizes an individual's knowledge in addition to the other parameters that may be used to determine an optimal route.

Turning now to the drawings, and referring initially to FIG. 1, an exemplary vehicle navigation system 10 in accordance with an embodiment of the present invention is illustrated. The vehicle navigation system 10 may include a processor 12, which may be a microprocessor, or any number of computing devices generally known to aid in the navigation of a user or a vehicle. The processor 12 controls many of the functions of the vehicle navigation system 10 through the utilization of the various components, such as a power supply 14, a memory 16 that includes a program 18, a transceiver module 20, a positioning system 22, a user interface 24 and a display 26. The processor 12 may be a Motorola MPC5200 processor, or any other suitable processor.

The power supply 14 may supply power to the processor 12 and other components of the vehicle navigation system 10. The power supply 14 may operate from power that is generated by the operation of an engine within a vehicle. Also, the power supply 14 may include permanent batteries, replaceable batteries, and/or rechargeable batteries that are connected to the power system of a vehicle.

Because the processor 12 controls the operation of the vehicle navigation system 10, which may be under the control of software programming, a memory 16 is coupled to the processor 12. The memory 16 may include dynamic random access memory, static random access memory, read-only memory, flash memory, or any combination of suitable memory types. The processor 12 may use the memory 16 to store data for the vehicle navigation system 10. The data may include traffic data, road maps, position data, driving patterns, and routing data, for example. Also, the processor 12 may use the memory 16 to store and to facilitate the execution of a software program, such as the routine or the program 18, which is discussed below.

The processor 12 may utilize the program 18 to perform operations on data to aid the vehicle navigation system 10 in determining a route. For example, the program 18 may perform specific instructions to assign weights to different types of data based on the parameters defined within an algorithm. By assigning different weights to segments of a specific route between two locations, an optimal route may be determined. The parameters that are used to assign the weights may vary depending on the weighting strategies being used by the algorithm.

To provide data to the processor 12 and memory 16 for use by the program 18, the communication module or the transceiver module 20 may include an antenna that is coupled to an RF transceiver. The transceiver module 20 may communicate with other devices or systems that are external to the vehicle navigation system 10 through the antenna. To communicate with other systems, the transceiver module 20 may utilize wireless technologies, such as Global Standard for Mobile (GSM), Time Division Multiple Access (TDMA), Code Division Multiple Access (CDMA), Frequency Division Multiple Access (FDMA), Advanced Mobile Phone Service (AMPS), and other suitable technologies.

Another source of data for the program 18 may be the position data that is provided from a positioning system 22. The positioning system 22 may include a Global Positioning System (GPS), a Dead Reckoning System (DRS), an altimeter, an odometer, and/or another suitable system. Through the use of position data, the positioning system 22 may provide the program 18 with the location of the vehicle navigation system 10 relative to a location on a stored map. For instance, if the positioning system 22 is a GPS, then it may receive position signals through the transceiver module 20 from multiple satellites to determine the specific location of the vehicle navigation system 10. Similarly, if the positioning system 22 is a DRS, it may operate from components, such as a gyroscope, odometer, compass, or other suitable components, to provide the location of the vehicle navigation system 10.

As an additional source of data, an operator of the vehicle navigation system 10 may utilize the user interface 24 and the display 26 to exchange data between the operator and the vehicle navigation system 10. For instance, the user interface 24 may be coupled to the processor 12 to enable the operator to provide data to the vehicle navigation system 10. The user interface 24 may include any type of device that allows the user to issue commands or enter data, such as a keyboard, buttons, switches, a light pin, a remote control, a touch pad, a microphone, and/or a voice recognition system, for example. The user interface 24 may be utilized to enter information, such as the origination or designation location, which may be utilized by the program 18. The display 26 may be coupled to the processor 12 to provide the operator with a visual image of the maps or textual information. The display 26 may include an LCD display, a CRT, LEDs, and/or an audio display.

The program 18 may provide different routes that may utilize data from the transceiver module 20, the positioning system 22, and/or the user interface 24. For instance, if the algorithm used by the program 18 places different weights on the speed limits associated with a road, then a highway may be weighted with a different value than a residential street because the highway has a higher speed limit. As a result of this weighting strategy, the highway is presented as the better route between the locations. With the addition of the traffic data, the algorithm may adjust the weights placed on the highway and the residential street. In certain situations, the traffic data may result in the residential street being a better route because of less traffic congestion. Thus, the program 18 may provide different routes based on the weighting strategies and the associated data utilized by the algorithm to generate an optimal route.

To provide enhanced performance to the vehicle navigation system 10, the program 18 may allow the operator to select an additional route that is based on an individual's knowledge. The additional route may incorporate the operator's knowledge or experience, or even another individual's knowledge or experience, when traveling between two locations. The individual's knowledge may be provided by: (1) the user entering a defined route; (2) accessing a route defined by another individual; and/or (3) utilizing a specific route a certain number of times, for example. The program 18 may provide an additional route as a default route, or the program 18 may provide multiple routes associated with specified origination and destination locations to allow the user to choose the desired route. As such, the program 18 may provide the user of the vehicle navigation system 10 with route selections that incorporate the operator's and/or another individual's experiences into the route selection process of the vehicle navigation system 10.

To record the individual's knowledge, the vehicle navigation system 10 may use a client profile that may be accessed by the program 18. The profile, which may be a file that is associated with the operator or a group of operators, may store routing data in the memory 16. The client profile may include routing data, a client identifier, and other suitable data. The routing data may include origination data, which may be an origination location, and destination data, which may be a destination location or ending location of the trip. In addition, the routing data may include the number of times the route has been utilized, any special flags indicating whether the route is a default route, and/or user defined routes that may be presented when a certain destination is entered into the vehicle navigation system 10. As such, the client profile may provide the program 18 with data relating to user defined routes based on an individual's knowledge or experience.

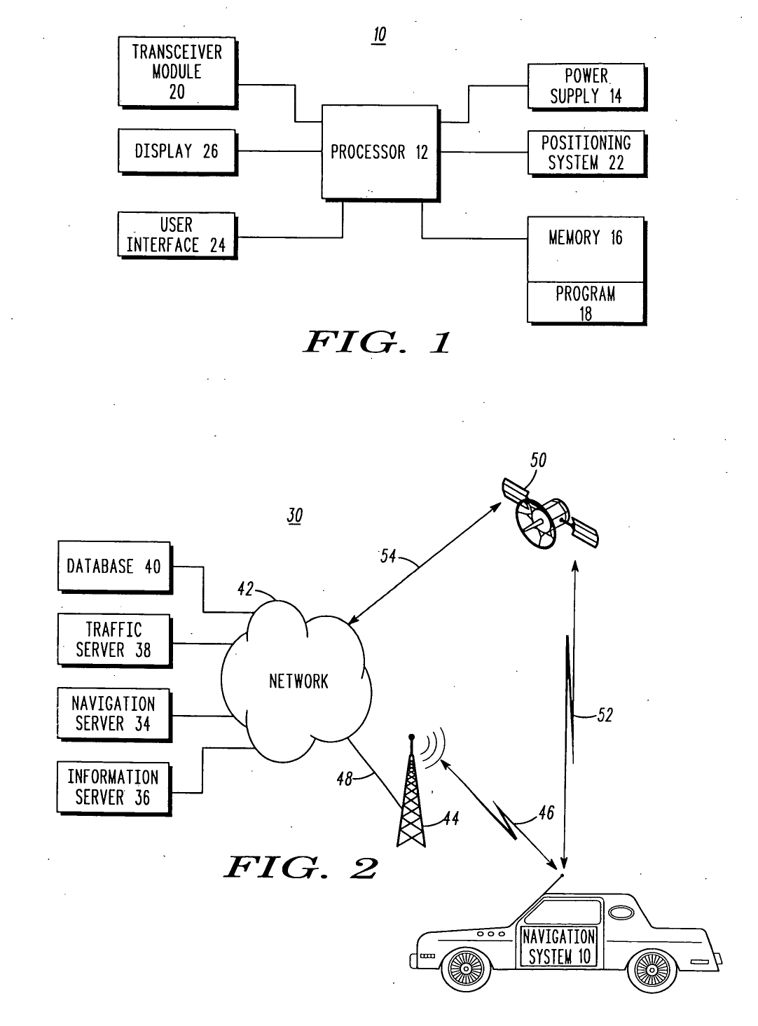

FIG. 2 illustrates a diagram of an exemplary navigation communication system 30 that incorporates the vehicle navigation system 10 in accordance with an embodiment of the present invention. In the exemplary navigation communication system 30, one or more vehicles 32 include a vehicle navigation system 10 that may communicate with one or more servers to transfer data that may aid in the navigation of the vehicles 32. The vehicles 32 may include a variety of types of transportation devices, such as a car, a truck, airplane, or any other suitable vehicle.

Through the use of the transceiver module 20, the vehicle navigation system 10 has the ability to exchange data with devices that are external to the vehicles 32. For instance, the vehicle navigation system 10 may communicate with different servers to provide navigation information to the user. The servers may include a navigation server 34, an information server 36, and a traffic server 38, as well as a database 40, that may be utilized by the vehicle navigation system 10 to access additional data. To communicate with each other, the servers 34-38 and the database 40 may communicate across a network 42. The network 42 may be a Local Area Network (“LAN”), Server Area Network (“SAN”), Metropolitan Area Network (“MAN”), or Wide Area Network (“WAN”), or other suitable networks.

To communicate with the vehicle navigation system 10, data may be transferred from the servers 34-38 and the database 40 to the vehicle navigation system 10 through different forms of wireless media. For instance, the vehicle navigation system 10 may communicate with a node 44 via a link 46. The node 44 may be a cellular communication station, telephone company office, or other similar structure. The communication with the node 44 may utilize a wireless technology, such as GSM, TDMA, CDMA, FDMA, and other suitable technology, as discussed above. The node 44 may deliver the data to the network 42 via a link 48. The link 48 may be a physical or wireless communication media that connects the node 44 to the network 42.

As an alternative communication route, the vehicle navigation system 10 may exchange data with the servers 34-38 and the database 40 via one or more satellites 50. The vehicle navigation system 10 may communicate with the satellites 50 via a link 52. The satellites 50 may transmit data to the network 42 via a link 54. The satellites 50 may utilize wireless technologies, as discussed above, to establish a communication path between the vehicle navigation system 10 and the servers 34-38 and the database 40.

The communication between the servers 34-38 and the database 40 may be managed by the navigation server 34. The navigation server 34 may be utilized to coordinate the exchange of data between the information server 36, the traffic server 38, and the database 40. The navigation server 34 may include software programs that are implemented to coordinate data exchanges with the vehicle navigation system 10. These exchanges may include the downloading of new code, updated maps, and other suitable data.

Additional navigation data may be provided to the vehicle navigation system 10 from the information server 36 and the traffic server 38. For instance, the information server 36 may provide mapping data and client data to the vehicle navigation system 10 directly or through the navigation server 34. The mapping data may include data that relates to the transportation infrastructures, such as different roads, speed limits, stoplights, stop signs, weather conditions, and other similar data. The client profile data may include identification data, owner data, location data, routing data, and other similar data. In addition, the traffic server 38 may provide traffic data that relates to traffic congestion or construction projects for different roads.

The servers 34-38 and the vehicle navigation system 10 may utilize the database 40 to access and store data related to the vehicle navigation system 10. The servers 34-38 may use the database 40 to store data that is not stored locally on the server 34-38, while the vehicle navigation system 10 may utilize the database 40 to store client data, route data, client profile data, or other data from the vehicle navigation system 10. Beneficially, by storing the data for the vehicle navigation system 10 in the database 40, an operator of one of the vehicles 32 may be able to access specific route data or client profiles in other vehicles. Accordingly, the operator of the vehicle 32 may access the database 40 to gain access to updated route data from other navigation systems that may include other operator's experience or knowledge in selecting a route between different locations.

Alternatively, the navigation server 34 may also operate in a server mode, with the navigation server 34 acting as a server and the vehicle navigation system 10 acting as a client. In this mode of operation, the navigation server 34 may include software programs, such as program 18, along with the client profiles to allow the selection of a route that is based on an individual's knowledge. The navigation server 34 may exchange information with the vehicle navigation system 10 and manage the route calculation for the vehicle navigation system 10. The user interaction with the vehicle navigation system 10 may be transmitted to the navigation server 34 in a continuous manner, when polled by the navigation server 34 or whenever the user interacts with the vehicle navigation system 10. Accordingly, the navigation server 34 in the server mode may provide the user with route selections that incorporate the operator's or another's experiences and/or preferences in a manner similar to the discussion of the vehicle navigation system 10 above.

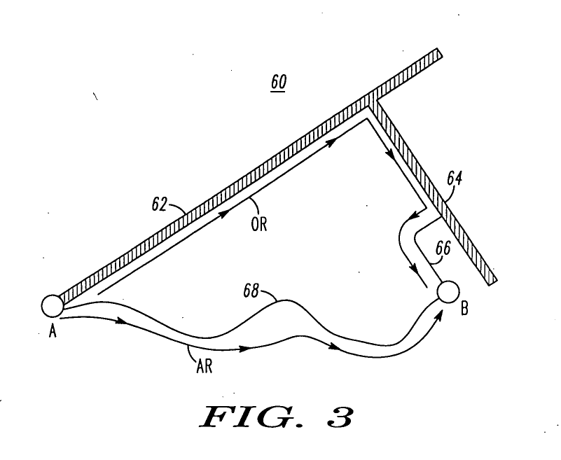

In either mode, the operation of the vehicle navigation system 10 is explained in relation to alternative routes in a diagram, generally designated by reference numeral 60, as shown in FIG. 3. The diagram 60 may be better understood by concurrently viewing FIGS. 1 and 2. In this diagram 60, the vehicle, which may be one of the vehicles 32 that includes the vehicle navigation system 10, may utilize multiple routes from an origination point A to a destination point B. An optimal route OR may be a route that is calculated by the program 18 of the vehicle navigation system 10. Also, an alternative route AR, which may be a route based on an individual's knowledge or experience, may be entered by an operator of the vehicle or learned by the program 18 through the use of the positioning system 22.

The operation of the vehicle navigation system 10 may provide the operator of the vehicle with multiple routes to a location. For example, the operator of the vehicle may enter in a destination point B into the user interface 24 of the vehicle navigation system 10. The program 18 may generate an optimal route OR that may be calculated based on the speed limit associated with the roads being utilized. As shown in FIG. 3, the optimal route OR may utilize a first expressway 62, a second expressway 64, and a road 66 from the origination point A to the destination point B. Also, with the operator entering in the destination point B, an alternative route AR, which may be a route based on an individual's knowledge or experience, may be presented to the operator by accessing a client profile associated with the destination. The alternative route AR, which may be entered by an operator of the vehicle or learned by the program 18 through the use of the positioning system 22, may utilize a road or roads 68 from the origination point A to the destination point B. As such, the alternative route AR may be a preferred route that is based on the operator's experience, personal preferences, unaccounted obstacles, or other similar factors.

Beneficially, the default route and the client profiles may enhance the use of the vehicle navigation system 10 for multiple operators in one or more vehicles 32. As an example of the benefits, a default route, such as the alternative route AR, may be stored within the memory 16 by a first operator. If a second operator plans to use the vehicle to travel to the destination point B, the second operator may enter the destination B into the vehicle navigation system 10 through the user interface 24. The program 18 may receive the data entered by the second operator along with the current data from the positioning system 22. Then, the program 18 may access the client profile or other data from the memory 16. Also, the program 18 may receive data from the servers 34-40, which may include traffic or road construction data. From this data, the program 18 may present images of routes AR and OR to the second operator through the display 26. The second operator may then select from the optimal route OR that is based on a specific weighting strategy or the alternative route AR that is based on the first operator's knowledge and experience. As such, the second operator may utilize the alternative route AR instead of the optimal route OR to take advantage of the first operator's knowledge and experience. Thus, the ability to utilize either route AR or OR provides the second operator with a route selection that incorporates the first operator's experience, which may include personal preferences, unaccounted for obstacles, or other similar data.

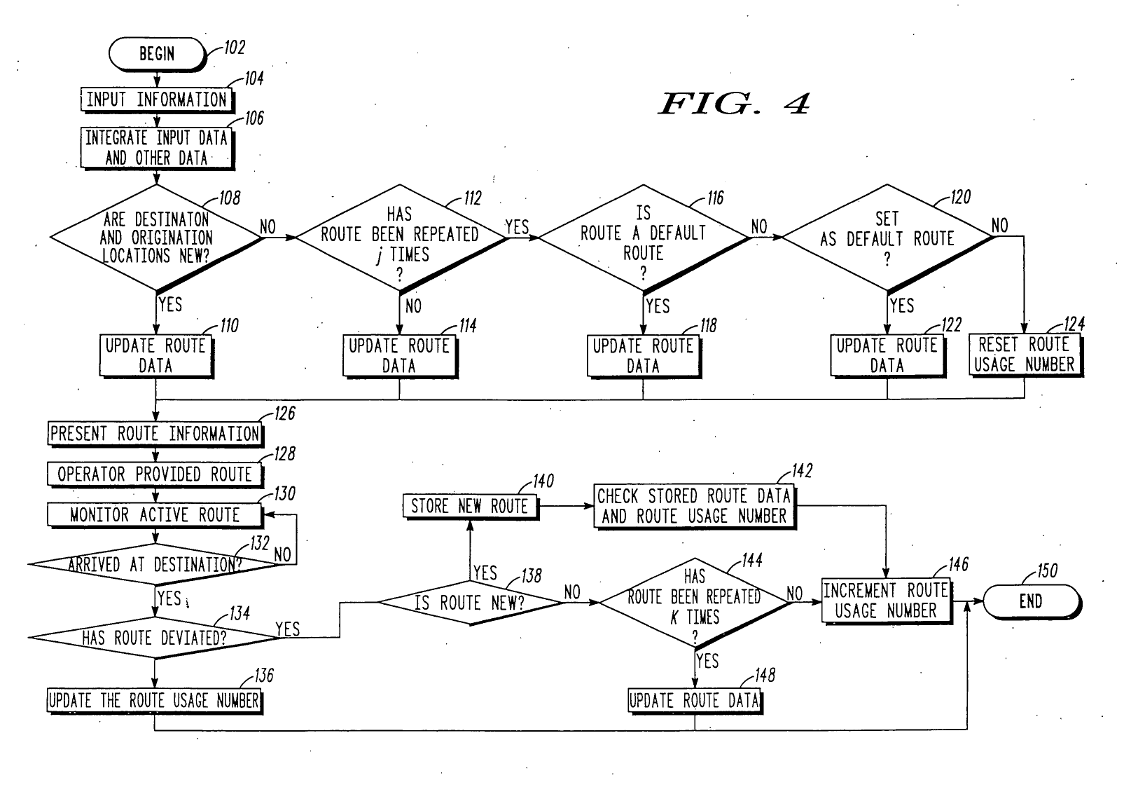

As depicted in FIG. 4, a flow diagram, generally designated by reference numeral 100, is illustrated of a process in accordance with an embodiment of the present invention. The flow diagram 100 may be better understood by concurrently viewing FIGS. 1-3. In the flow diagram 100, the vehicle navigation system 10 in the vehicle 32 may interact with remote systems, such as servers 34-38 and the database 40, or include internal components 12-26 to determine a route between different locations. As will be explained in greater detail below, the vehicle navigation system 10 provides the operator with an operator defined or preferred route that may be based on the operator's or another operators' experience. It should also be noted that the vehicle navigation system 10 may also be a portable device that provides the user with functionality that is separate from the vehicle 32.

The process begins at block 102. At block 104, the operator of the vehicle 32 may enter information into the vehicle navigation system 10 through a user interface 24. The operator or input data may include destination data and/or origination data that are entered into the vehicle navigation system 10. The operator data is integrated with other data at block 106. The integration may include utilizing the program 18 to combine the operator data with other data, such as the client profile, route data, or position data, for example. The data may be accessed from the memory 16 or the positioning system 22 of the vehicle 32. Also, the program 18 may access data from the servers 34-38 and the database 40 through the transceiver module 20.

At block 108, the vehicle navigation system 10 may determine if the destination and origination locations are new or have been previously utilized. To determine if the route is new or has been previously utilized, the destination and origination locations may be compared to route data. If the destination and origination locations are new, then the vehicle navigation system 10 may update the route data associated with the destination and origination locations, as shown in block 110. With the route being new, the updating of the route data may create a new record, which may be a file accessible by the program 18. The record may associate the route data with the destination and origination locations. The new record of the route data may be stored in the memory 16, the servers 34-38, or the database 40 for later retrieval once the route is completed.

However, if the route has been previously utilized, the vehicle navigation system 10 may determine if the route has been repeated a specified amount of times, such as “J” times, as shown in block 112. The determination of the number of times that the route has been utilized may be referred to as a route usage number, which may be a specific number “J”. The route usage number may be defined or configured by the operator entering a value into the user interface 24. For example, if the operator configures the vehicle navigation system 10 to utilize the route a single time, then taking the route may define the route as a default route. Alternatively, if the vehicle navigation system 10 is configured to utilize a specific route ten times, then the route data is stored and the route usage number is incremented until the route has been repeated ten times. Once, the route has been repeated ten times, the operator may set the route as a default route.

If the route has not been repeated a specified number of times, then the vehicle navigation system 10 may update the route data to indicate that the destination and origination locations are being used at block 114. However, if the route has been taken the specified number of times or greater, then the vehicle navigation system 10 may determine if the route is a default route at block 116. If the route is a default route, then the route data may be updated at block 118. However, if the route is not a default route, the operator of the vehicle 32 may determine whether the route is to be set as a default route at block 120. The setting of the default route may be accomplished by setting a condition or a flag to indicate that the route is a default route. If the operator sets the route as a default route, then the route data and client profile may be updated at block 122. The updating of the route data may include storing the route data in the memory 16, in the servers 34-38, or in the database 40, as discussed above. However, if the operator does not set the route as a default route, then the number of times the route has been utilized may be reset at block 124. The resetting of the route usage number may involve decreasing the number of times that the route has been utilized or indicating that the route is not to be a default route. Also, the operator may elect to discard a default route because the route is no longer used or unnecessary. To prevent the route from being presented as a default route, the route may be defined as a non-default route by setting the route usage number to a large value or associating a flag, such as a specific value, with the route to indicate that it is not to be a default route.

After blocks 110, 114, 118, 122, and 124, the operator may be presented with the route data at block 126. The route data may assist the operator in selecting a route between the destination and origination points based on the data stored within the vehicle navigation system 10. The routing data may include an operator preferred route from the client's profile, a route that is calculated by the program 18, or a combination of different routes, which may include operator defined routes and/or different routes calculated based on different weighting strategies. Then, the operator is provided route information in block 128. The operator may manually select a route through the user interface 24, or the vehicle navigation system 10 may automatically select the route to be provided to the operator. At block 130, the actual route taken by the vehicle 32 may be monitored and may set a condition to indicate that it is a default route. The actual route utilized may be monitored through the use of the positioning system 22 by the program 18 or may be monitored through the use of the servers 34-38. This route may be the active route, which is being monitored by the vehicle navigation system 10.

At block 132, the vehicle navigation system 10 may determine if the vehicle 32 has arrived at the destination. If the vehicle 32 has not arrived at the destination, then the actual route taken by the vehicle 32 may be monitored in block 130, as discussed above. However, if the vehicle 32 has arrived at the destination, then the vehicle navigation system 10 may determine if the route utilized is similar to the selected route or other routes that have been previously utilized between the origination and destination locations, as shown in block 134. If the vehicle 32 has not deviated from the route, then route usage number may be updated at block 136. The determination regarding the deviation of the route may involve accessing other data about the route, such as the width of the road, construction on the road, traffic accidents, or other similar data to determine if the deviation was unavoidable.

However, if the route has deviated from the specified route, then the vehicle navigation system 10 may determine if the route is new, as shown in block 138. If the route is not a new route, then the vehicle navigation system 10 may determine whether the route has been repeated a specific number of times, such as “K” times, as shown in block 144. However, if the route between the destination and origination locations is new, then the vehicle navigation system 10 may store the route data associated with the destination and origination locations, as shown in block 140. As discussed above with block 110, the storing of a new route may include creating a new record, which may be a file accessible by the program 18. At block 142, the vehicle navigation system 10 may verify the stored route data and route usage number to confirm that the new route has the route usage number and route data associated with it. Then, the vehicle navigation system 10 may increment the route usage number, as shown in block 146.

At block 144, the vehicle navigation system 10 may determine whether the route has been repeated “K” times. The value of “K” may be any number defined by the user of the vehicle navigation system 10 or a value stored within the memory 16. If the route has been repeated the specific number of times, then the vehicle navigation system 10 may update the route data, as shown in block 148. However, if the route has not been repeated the “K” times, then the route usage number may be incremented. Accordingly, after blocks 136, 146 and 148, the process ends at block 150.

Alternatively, it should be appreciated that the navigation server 34 may also operate in a server mode with the navigation server 34 acting as a server and the vehicle navigation system 10 acting as a client. In this mode of operation, the navigation server 34 may determine if the destination and origination locations are new or have been previously utilized as shown in block 108. Also, the navigation server 34 may update the route data, determine if the route is a default route, and set a route as a default route, as shown in block 110-124. Further, the navigation server 34 may provide the route data to the vehicle navigation system 10 and monitor the route taken by the vehicle, as shown in blocks 126-148. Throughout each of these exchanges, the vehicle navigation system 10 may communicate the relevant data to the navigation server 34. As such, the navigation server 34 may provide the operator with route selections in a manner similar to the discussion of the vehicle navigation system 10 above.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A vehicle navigation system, comprising:
a vehicle; and
a navigation system housed in the vehicle, the navigation system comprising:
a processor,
a positioning system coupled to the processor for determining position data relating to a location of the vehicle;
a memory coupled to the processor to store data for the processor; and
a program for use by the processor configured to:
determine if position data and destination data correspond to an operator preferred route stored in memory;
provide the operator preferred route if the position data and destination data correspond to the operator preferred route; and
update the operator preferred route by monitoring the position data.

2. The vehicle navigation system, as set forth in claim 1, wherein the navigation system comprises a display for providing images to an operator of the vehicle.

3. The vehicle navigation system, as set forth in claim 1, wherein the navigation system comprises a user interface configured to facilitate entry of the destination data by a vehicle operator.

4. The vehicle navigation system, as set forth in claim 3, wherein the user interface comprises a keyboard and a display.

5. The vehicle navigation system, as set forth in claim 1, wherein the operator preferred route is defined by the number of time that a specific route is utilized.

6. The vehicle navigation system, as set forth in claim 1, wherein the operator preferred route is defined by the operator based on preferences of the operator.

7. A system, comprising:
a vehicle having a navigation system; and
a navigation server adapted to communicate with the navigation system via a network, the navigation server having a program that is adapted to:
generate an optimal route from an origination location to a destination location;
access a client profile stored in a memory that is coupled to the navigation server to determine whether a preferred route is defined; and
provide at least one of the optimal route and the preferred route to the operator of the vehicle.

8. The system, as set forth in claim 7, wherein the network comprises a satellite link between the navigation system and the navigation server.

9. The system, as set forth in claim 7, wherein the network comprises a cellular node between the navigation system and the navigation server.

10. The system, as set forth in claim 7, wherein the program interacts with a traffic server to integrate traffic data with the origination location and the destination location to generate the optimal route.

11. The system, as set forth in claim 7, wherein the program interacts with an information server to integrate mapping data with the origination location and the destination location to generate the optimal route.

12. A system, comprising:
a processor;
a positioning module in communication with the processor for determining location data that relates to a location of a device;
an interface module adapted to communicate data to a user of the device; and
a routine utilized by the processor, the routine configured to:
utilize location data from the positioning module;
utilize destination data provided to the interface module;
determine whether the location data and the destination data correspond to a defined route stored in memory;
provide the defined route if the location data and destination data correspond to the defined route;
generate an optimal route if the location data and the destination data do not correspond to the defined route; and
provide the optimal route if the location data and the destination data do not correspond to the defined route.

13. The system, as set forth in claim 12, comprising a communication module that is coupled to the processor and configured to exchange data with a system external to the device.

14. The system, as set forth in claim 13, wherein the routine is further adapted to exchange navigation data and location data via the communication module with the external system via a wireless link.

15. The system, as set forth in claim 12, wherein the interface module utilizes hands-free voice capability.

16. The system, as set forth in claim 12, wherein the interface module comprises a keyboard and display.

17. The system, as set forth in claim 12, wherein the positioning module is a global positioning system.

18. A method of operating a navigation system, the method comprising the acts of:
entering a destination location at a device;
receiving an origination location;
determining if the origination location has been utilized with the destination location based on stored data;
providing a default route if a default route has been defined in memory;
generating an optimal route if the default route is not defined for the origination location and the destination location; and
providing an optimal route if a default route is not defined.

19. The method, as set forth in claim 18, comprising setting a default route if a condition is set.

20. The method, as set forth in claim 19, comprising setting the condition if the number of times the origination location has been utilized with the destination location is greater than or equal to a specific number of times.

21. The method, as set forth in claim 19, comprising setting the condition if a user enters that an actual route is a default route.

22. The method, as set forth in claim 18, comprising monitoring an actual route from the origination location to the destination location.

23. The method, as set forth in claim 18, wherein determining further comprises accessing stored data in a database external to the device.

24. The method, as set forth in claim 18, wherein determining further comprises accessing stored data in memory within the device.

25. A method of operating a navigation system, the method comprising the acts of:
entering destination data into a user interface of a vehicle;
receiving origination data;
communicating the origination data and the destination data to a server via a network;
accessing a client profile;
comparing the client profile with the origination data and the destination data;
determining if the origination data and the destination data correspond to a defined route in the client profile that is based on a user's experience and knowledge;
generating an optimal route if the origination data and the destination data do not correspond to the defined route; and
communicating at least one of the optimal route and the user defined route to the vehicle.

26. The method, as set forth in claim 25, comprising presenting the at least one of the optimal route and the user defined route to an operator of the vehicle.

27. The method, as set forth in claim 25, comprising setting the user defined route if a number of times a route is associated with the origination data and the destination data is greater than or equal to a specific value.

28. The method, as set forth in claim 25, wherein communicating comprises utilizing a satellite link between the server and the vehicle.

29. The method, as set forth in claim 25, comprises monitoring an actual route from an origination location that corresponds to the origination data to a destination location that corresponds to the destination data.

30. The method, as set forth in claim 25, wherein generating the optimal route is automatically calculated based on a predefined routine.

31. A method of manufacturing a navigation system comprising the acts of:
providing a navigation system comprising a processor;
coupling a user interface to the processor for entering data from an operator;
coupling a positioning module to the processor for determining location data;
coupling a display to the processor for presenting route data to an operator;
coupling a memory to the processor; and
configuring a program within the memory that is adapted to:
receive destination data from the user interface;
receive origination data from one of the positioning module and the user interface;
present a preferred route if with the origination data and the destination data correspond to the preferred route;
generate an optimal route if the origination data and the destination data do not correspond to the preferred route; and
present the optimal route if with the origination data and the destination data do not correspond to the preferred route.

32. The method, as set forth in claim 31, comprises coupling a communications module to the processor.

33. The method, as set forth in claim 32, comprises configuring the program to communicate with an external server to download traffic data via the communications module.

34. The method, as set forth in claim 32, comprises configuring the program to communicate with an external server to download construction data via the communications module.
